(19) United States
(12) Patent Application Publication
(10) Pub. No.: US 2026/0330929 A1
(43) Pub. Date: Oct. 22, 2026

(54) QUICK RESPONSE (QR) CODE AND PLAYER SELF-SERVICE

(71) Applicant: IGT, Las Vegas, NV (US)

(72) Inventors: Jeff Shepherd, Reno, NV (US); Kevin Higgins, Reno, NV (US)

(21) Appl. No.: 19/184,302

(22) Filed: Apr. 21, 2025

(51) Int. Cl. G07F 17/32; G06F 16/955

(52) U.S. Cl. CPC G07F 17/3267; G06F 16/9554; G07F 17/323; G07F 17/3258

(57) ABSTRACT

Embodiments of the present disclosure are directed to initiating activities to process events occurring at a gaming system. According to one embodiment conducting an activity with a player of an electronic game can comprise executing an electronic game, detecting an event occurring within the electronic game, presenting an indication of an available activity, receiving an indication of acceptance of the indicated available activity by the player of the electronic game, and initiating, the indicated available activity with the player of the electronic game in response to the received indication of acceptance of the indicated available activity from the player of the electronic game.

### BACKGROUND

The present disclosure is generally directed to electronic gaming and more particularly to initiating activities to process events occurring at a gaming system.

Casinos are labor intensive operations for processing player signups, jackpot processing and other activities. For example, when a jackpot is hit by a player, a jackpot attendant comes to the player’s machine and processes the win by having the player fill out the requisite government tax forms, key off the player’s jackpot, and pay the player their winnings. Other variations of this flow are possible, such as keying of the winnings to the credit meter of the gaming machine, or keying off the hand pay to a ticket or receipt that is redeemable at a cashier’s cage for the won amount, etc. In such cases, jackpots are typically paid out in cash. This can also create security or personal safety risks for players.

### BRIEF SUMMARY

Embodiments of the present disclosure are directed to initiating and conducting activities to process events occurring at a gaming system. According to one embodiment, a gaming system can comprise a processor and a memory coupled with and readable by the processor. The memory can store therein a set of instructions which, when executed by the processor, causes the processor to execute an electronic game, detect an event occurring within the electronic game, present, to a player of the electronic game, an indication of an available activity, receive an indication of acceptance of the indicated available activity by the player of the electronic game, and initiate the indicated available activity with the player of the electronic game in response to the received indication of acceptance of the indicated available activity from the player of the electronic game.

For example, the indication of the available activity can comprise a Quick-Response (QR) code. In some cases, the QR code can further comprise a transaction identifier. Additionally, or alternatively, the QR code can further comprise an identifier of the gaming system. In another example, the indication of the available activity can comprise a message to the player of the electronic game.

In some cases, the event occurring within the electronic game can comprise a win event. In such cases, the available activity can comprise completing a form related to the win event. Additionally, or alternatively, the available activity can comprise creating an account for the player of the electronic game, bonusing related activity for the electronic game, presenting an offer to the player of the electronic game, processing a jackpot of the electronic game, and/or other activity.

According to another embodiment, a system can comprise a communications network and a gaming system coupled with the communications network. The gaming system can comprise a processor and a memory coupled with and readable by the processor of the gaming system. The memory of the gaming system can store therein a set of instructions which, when executed by the processor of the gaming system, causes the processor of the gaming system to execute an electronic game, detect an event occurring within the electronic game, and present, to a player of the electronic game, an indication of an available self-service activity.

The system can further comprise a host system coupled with the communications network. The host system can comprise a processor and a memory coupled with and readable by the processor of the host system which, when executed by the processor of the host system, can cause the processor of the host system to initiate the indicated available activity with the player of the electronic game in response to an indication of acceptance of the indicated available activity from the player of the electronic game.

For example, the indication of the available activity can comprise a Quick-Response (QR) code. In such cases, the QR can comprise a link to a Uniform Resource Locator (URL) provided by the host system. In another example, the indication of the available activity can comprise a message to the player of the electronic game. In such cases, the message to the player of the electronic game can instruct the player to connect with the gaming system via a device of the player.

In some cases, the device of the player can comprise a smartphone and the message can comprise a text message to the smartphone of the player. In such cases, the text message can be sent by the host system in response to a request from the gaming system. In other cases, the device of the player of the electronic game can comprise an augmented reality device or a virtual reality device.

According to yet another embodiment, a method for conducting a self-service activity with a player of an electronic game can comprise executing an electronic game, detecting an event occurring within the electronic game, presenting an indication of an available activity, receiving an indication of acceptance of the indicated available activity by the player of the electronic game, and initiating, the indicated available activity with the player of the electronic game in response to the received indication of acceptance of the indicated available activity from the player of the electronic game.

Additional features and advantages are described herein and will be apparent from the following Description and the figures.

### BRIEF DESCRIPTION OF THE SEVERAL VIEWS OF THE DRAWINGS

FIG. 1 is a diagram illustrating an exemplary environment in which embodiments of the present disclosure may be implemented.

FIG. 2 is a block diagram illustrating additional details of components of an exemplary gaming system according to one embodiment of the present disclosure.

FIG. 3 is a block diagram illustrating additional details of components of an exemplary host system according to one embodiment of the present disclosure.

FIG. 4 is a flowchart illustrating an exemplary process for initiating and conducting activities to process events occurring at a gaming system according to one embodiment of the present disclosure.

FIG. 5 is a flowchart illustrating an exemplary process for initiating and conducting activities to process events occurring at a gaming system according to another embodiment of the present disclosure.

### DETAILED DESCRIPTION

Embodiments of the present disclosure are directed to initiating and conducting activities to process events occurring at a gaming system. Embodiments enable a player of an electronic game to take advantage of a mobile device to self-service various aspects of casino operations. A Quick Response (QR) code can be used as an initial communication with the player. By scanning the code, the player’s mobile device can navigate to a web site for self-service and other types of activities that would have traditionally required casino staff to handle.

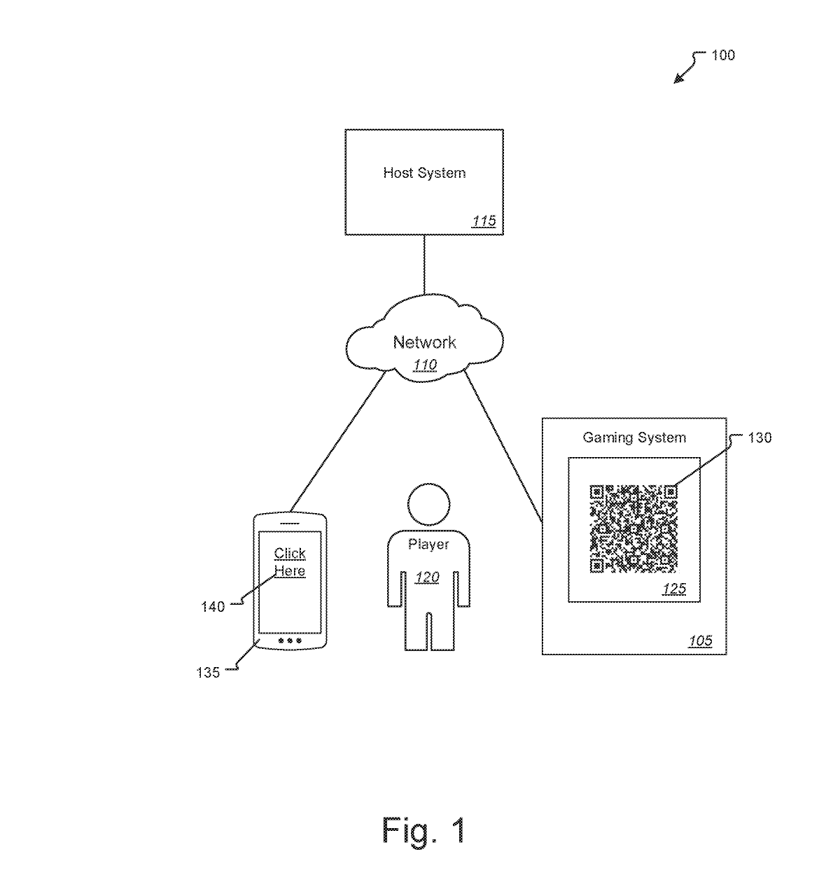

FIG. 1 is a diagram illustrating an exemplary environment in which embodiments of the present disclosure may be implemented. As illustrated in this example, the environment 300 can comprise a gaming system 105 such as any Electronic Gaming Machine (EGM), kiosk, or similar gaming system as may be found in a casino or other gaming venue. The gaming system 105 can execute any of a variety of electronic games including, but not limited to slots, video slots, video poker, keno, etc. to be player by a player 110. The gaming system 105 can be coupled with a communication network 110. The communication network 110 can comprise any one or more wired and/or wireless, local-area and/or wide-area networks as known in the art including, but not limited to, the Internet. Also coupled with the communication network 115 can be one or more gaming venue host systems 120 and a responsible gaming system 125. The gaming venue host system 120 can comprise any one or more servers and/or other computing devices such as commonly used to manage gaming systems 105 and other systems in a casino or other gaming venue.

Embodiments of the present disclosure are directed to initiating communication with the player 120, for player self-service, using a QR code 130 that is triggered by some event. The QR code 130 can be presented to the player 120 through a display 125 on the gaming system 105, or other player interface, such as the player’s mobile device 135. The player 120 can scan the QR code 130 and navigate to a website hosted by the host system 115 to perform whatever action that triggered the QR code 130. Beyond a Universal resource Locator (URL) to navigate to a website, the QR code 130 may contain additional data such as a unique transaction ID, gaming system 105 ID, gaming system asset number, or other data useful in the communication. While casino staff is a relatively scarce resource, enabling the player to self-service some event like a jackpot allows for more efficient and timely processing of the event. The player 120 can self-service the transaction without waiting for a casino host to assist them. Additionally, sometimes players deal with sensitive data such as government documents required to process a jackpot. Filling out these documents on a mobile device 135 is far more secure than filling them out on a display 125 of the gaming system 105. Furthermore, the whole workflow can ensure the player gets electronic copies of all documents, which may be easier to manage or maintain than obtaining physical copies of those documents from the casino.

In the one embodiment, gaming system 105 can pop up a QR code 130, resulting from some triggering event, that can be scanned by the player 120 using a mobile device 135 to assist the player 120 in some sort of self-service activity that previously required a casino host, or other casino personnel, to interact with the player 120. QR code 130, when scanned with a mobile device 135, can cause the mobile device 135 to navigate to a web page because the address of the website is encoded in the QR code 130. Additional parameters can also be added to the URL represented by the QR code to allow the player 120 to perform the self-service activity. The self-service activity can be a variety of casino and non-casino related activities, including signing up for a card or a player’s loyalty account, signing up for a cashless wagering account, bonusing, offers, advertisements, jackpot processing, etc. A variety of systems can make use of QR codes to communicate with the player including, but not limited to, patron management, bonusing, the Slot Machin Interface Board (SMIB), etc. It should be noted rather than a QR code, other embodiments are also possible to kick off or begin the self-service transaction process. For example, the player 120 could be prompted to scan an Near-Field Communication (NFC) tag with their mobile device to begin a self-service transaction, connect to a BlueTooth endpoint, connect to a temporary Wifi network for the transaction, engage the gaming system 105 or service window using a Virtual Reality (VR) or Augmented Reality (AR) device to perform the transaction, request of the player to enter their mobile phone number where the system sends them a text message (or other appropriate message, such as e-mail, etc) to start or begin the transaction.

One case where a QR code can replace the interaction between a player and a host can be the “hot” player signup use case. The host system 115 can see certain aspects of an uncarded player’s gaming activity. If they are a “hot” player, it means they have high coin-in and they might be an attractive target to sign up to for a player’s card. When a hot player is detected, the host system 115 can trigger the gaming system 105 to display a QR code 130, e.g., in the service window. Once displayed, the player 120 can be invited to scan the QR code 130 with their mobile device 135, e.g., via associated text and/or marketing material to entice the player 120 to scan the QR code 130 or otherwise begin a self-service transaction. For example, the player may be alerted to or offered certain rewards or benefits they may obtain once completing the sign-up process. Upon scanning the QR code 130, the player’s mobile device 135 (or VR/AR device) can be navigated to a website hosted by the host system 115 that invites the player 120 to sign up for a player card. The text or marketing material on the website could be general, or it could provide further information about the transaction, including the benefits the player would receive when completing the transaction, such as a bonus, points for their previous play, a point multiplier, a certain player’s loyalty club rank or level of status, etc. The player 120 can accept and sign up, or decline. After accepting the offer for self-service, the player may be asked to provide some additional details, such as Personally Identifiable Information (PII).

The contents of the QR code 130 can be different depending on the use case of the self-service flow. For example, for the hot player use case, it may be useful to know the gaming system 105 ID and, perhaps, the game theme the player 120 is playing. Therefore, the QR code 130 can be a combination of a website plus some or no parameters, and parameters of all different meanings and intents depending on the needs of the use case.

Further security mechanisms or flows may be used for the player to complete the self-service transaction and mitigate security risks. The most common security risk in this scenario is that of another player or “skimmer” seeing this displayed QR code 1310, or engaging the gaming system 105 instead of the real player. The gaming system 105 and/or host system 115 can mitigate this risk by asking the player 120 at the gaming system 105 to confirm the transaction in some way which an attacker could not confirm or approve the transaction. For example, the player’s mobile device 135 may display a unique code once the web page referenced by the QR code 130 is loaded and the code can be unique for each load of that URL. The player 120 can then be prompted to enter this code into the gaming system 105. The host system 115 can then know which self-service web transaction actually corresponds to the real player at the gaming system 105. Other approaches are also possible, depending upon the mechanisms used to start the transaction, as previously discussed.

Today when a jackpot is hit by a player, a jackpot attendant comes to the player’s machine and processes the workflow by having the player fill out the requisite government tax forms, key off the player’s jackpot and pay the player their winnings. Other variations of this flow are possible, such as keying of the winnings to the credit meter of the gaming system 105, or keying off the handpay to a ticket or a handpay receipt that is redeemable at a casier’s cage for the won amount, etc. This entire workflow can be initiated via a QR code that can be scanned by the player 120 and allow the player 120 to fill out the forms on their own mobile device 135, designate the winnings for disposal to their wagering account, to their bank, or to be paid via a voucher or in person, as well as to automatically key off the jackpot so that the gaming system 105 can be returned to play. This approach might even be preferred by many players, as jackpots are typically paid out in cash, and that creates security or personal safety risks for players.

According to one embodiment, the player’s funds can be transferred to the player’s gaming wallet prior to keying off the jackpot. Other options for the funds can include, but are not limited to, requesting personnel to come pay off the jackpot in cash, requesting a voucher as the method of jackpot payoff, transferring the funds to the player’s bank account via the player’s wallet or directly through the host system 115 and network nodes from the credit meter of the gaming system 105. Transfers of jackpot winnings to the player’s bank account may come with an added benefit, where the transfer may not settle for a number of days, which would make the pursuit of players who won a jackpot by criminals not as successful as they are today as the players wouldn’t immediately have the funds from the jackpot.

It should be appreciated that the QR code 130 method of player communication and notification is not limited to being displayed on the gaming system 105. Any player facing display can be used to display the QR code 130. For example, the QR Code 130 can be displayed by a kiosk or other player interface including, but not limited to, kiosks, sports, online gaming displays.

The QR code 130 can include a URL that navigates a player’s mobile device to a web site. The web site can be a casino managed web site or some other web site that is not managed by the casino.

Because the QR code 130 is flexible in that it provides a virtually limitless number of different websites, the QR code/URL could represent other forms of player communications that include, but are not limited to, advertisements, app download suggestions, links to social media, a mechanism to launch the casino’s mobile application, and informational notifications.

Triggers that launch QR codes 130 on the gaming system 105 for display to players can be based on some triggering event. The triggering event can be machine generated, time based, system based, externally based, or any other stimulus that can be imagined.

QR codes 130 can represent bonuses or offers to players. By using a QR code 130, uncarded players can be targeted. When a player 120 is offered a bonus or offer via a QR code 130, the player 120 can navigate to the web site via their mobile device 135 and decide whether or not to accept the offer. If the player 120 decides to accept the offer, the offer can be delivered in a variety of ways including, but not limited to, delivery of credits to the credit meter, delivery of credits via a voucher, or delivery of a bonus or offer to the player’s mobile device wallet, delivery of the credits to a player’s bank account, etc.

According to one embodiment, the host system 115 can provide an Application Programming Interface (API) to third parties that allows for the third-party to present a URL encoded with a website to navigate to and a transaction ID. The URL and transaction ID and other data can be transmitted to the host system 115 that can forward the URL on to the gaming system 105 where the URL can be rendered into a QR code 130 for scanning. Once a player 120 scans the QR code 130, the player 120 can then be presented with the website that is encoded in the URL. The transaction ID also can be presented to the website to close the loop on the transaction.

A practical example for the third-party scheme can be for a third-party to be subscribed to an event stream emitted by the host system 110 and that includes game events. When an event that is of interest to the third-party is generated, the third-party can detect the event and call the API effectively allowing the third-party to attempt to communicate with the player 120. This communication can include offers, bonuses or other functions similar to the ones described above.

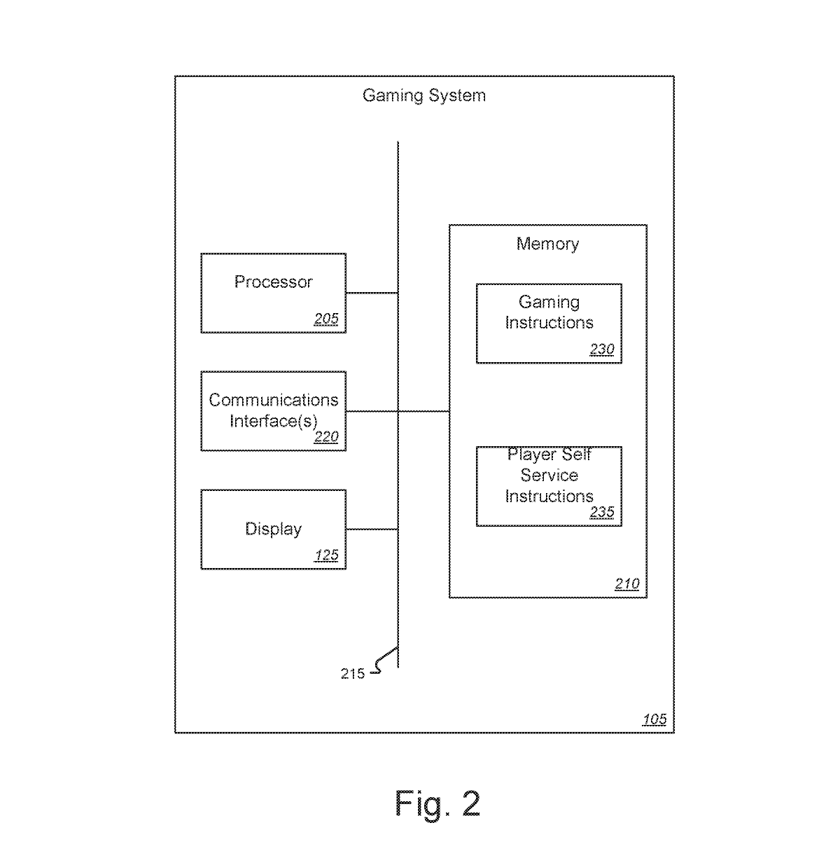

FIG. 2 is a block diagram illustrating additional details of components of an exemplary gaming system according to one embodiment of the present disclosure. As illustrated in this example, a gaming system 105 such as described above can comprise a processor 205. The processor 205 may correspond to one or many computer processing devices. For instance, the processor 205 may be provided as silicon, as a Field Programmable Gate Array (FPGA), an Application-Specific Integrated Circuit (ASIC), any other type of Integrated Circuit (IC) chip, a collection of IC chips, or the like. As a more specific example, the processor 205 may be provided as a microprocessor, Central Processing Unit (CPU), or plurality of microprocessors that are configured to execute the instructions sets stored in a memory 210. Upon executing the instruction sets stored in memory 210, the processor 205 enables various functions of the gaming system 105 as described herein.

The memory 210 can be coupled with and readable by the processor 205 via a communications bus 215. The memory 210 may include any type of computer memory device or collection of computer memory devices. Non-limiting examples of memory 210 include Random Access Memory (RAM), Read Only Memory (ROM), flash memory, Electronically-Erasable Programmable ROM (EEPROM), Dynamic RAM (DRAM), etc. The memory 210 may be configured to store the instruction sets depicted in addition to temporarily storing data for the processor 205 to execute various types of routines or functions.

The processor 205 can also be coupled with one or more communication interface(s) 220 and a display device 125 via the communications bus 215. The communication interface(s) 220 can comprise, for example, an Ethernet, Bluetooth, WiFi, cellular, and/or other type of wired and/or wireless communications interface. Via the communication interface(s) 220, the gaming system 105 can communicate with other devices and/or systems through a communications network 115 as described above. The display device 124 can include, but is not limited to a display device such as a Liquid Crystal Display (LCD), Light Emitting Diode (LED), Organic Light Emitting Diode (OLED), or other type of display.

The memory 210 can store therein a set of gaming instructions 230 which, when executed by the processor 205, cause the processor 205 to execute an electronic game. The electronic game can be any of a wide variety of electronic games of chance including, but not limited to, slots, video slots, video poker, keno, blackjack, etc. to be played by a player, e.g., in a casino or other gaming venue.

The memory can also store therein a set of player self-service instructions 235 which, when executed by the processor 205 can cause the processor 205 to detect an event occurring within the electronic game, e.g., a win event, and present, through the display device, an indication of an available activity. In some cases, the indication of the available activity can comprise a QR code 130. In some cases, the QR code 130 can further comprise a transaction identifier. Additionally, or alternatively, the QR code 130 can further comprise an identifier of the gaming system 105. The available activity can comprise, for example, completing a form related to the win event. Additionally, or alternatively, the available activity can comprise creating an account for the player of the electronic game, bonusing related activity for the electronic game, presenting an offer to the player of the electronic game, processing a jackpot of the electronic game, and/or other activity.

The player self-service instructions 235 can further cause the processor 205 to receive an indication of acceptance of the indicated available activity by the player of the electronic game. The indication of acceptance can comprise, for example, the player pairing a mobile device 135 with the gaming system or a message from the mobile device or host system 115 indicating acceptance by the player 120. The player self-service instructions 235 can cause the processor 205 to initiate the indicated available activity with the player of the electronic game in response to the received indication of acceptance of the indicated available activity from the player of the electronic game. Initiating the activity can comprise launching a process and conducting the activity on the gaming system 105 and/or requesting processing by a host system 115 to conduct the activity in whole or in part.

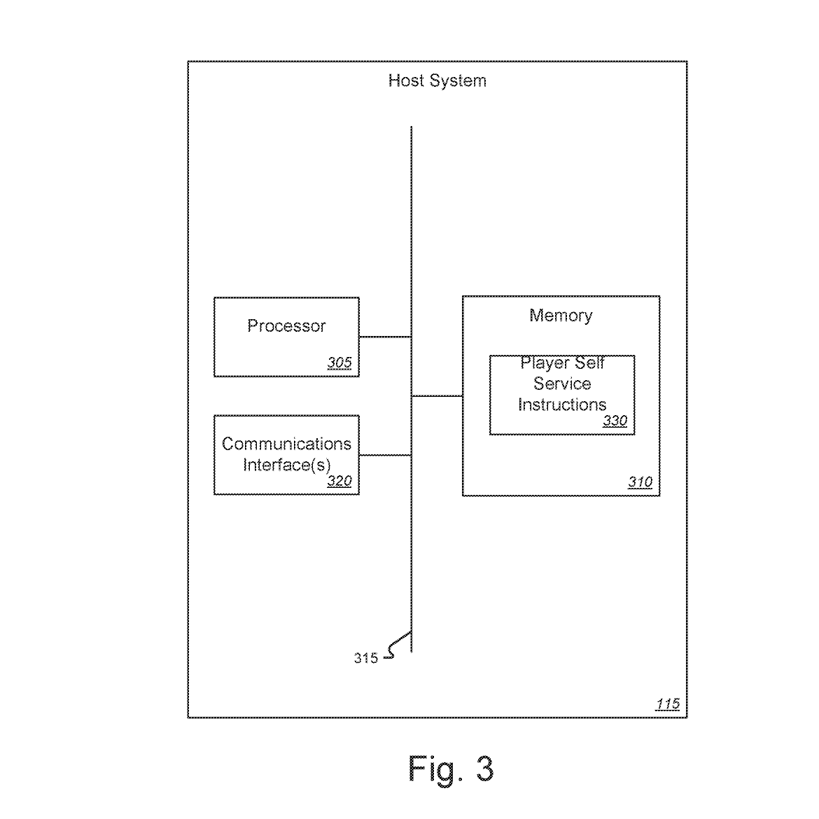

FIG. 3 is a block diagram illustrating additional details of components of an exemplary host system according to one embodiment of the present disclosure. As illustrated in this example, a responsible gaming system 125 can comprise a processor 305 such as any of the various types of processors described above. A memory 310 can be coupled with and readable by the processor 305 via a communications bus 315. The memory 310 can comprise any one or more of the different types of volatile and/or non-volatile memories described above. The processor 305 can also be coupled with one or more communication interfaces 320. The communication interfaces 320 can comprise, for example, an Ethernet, Bluetooth, WiFi, cellular, and/or other type of wired and/or wireless communications interface.

The memory 310 can store therein a set of player self-service instructions 330 which, when executed by the processor 305, cause the processor 305 to receive, through the communications interface 320, notification of an event, e.g., a win event, occurring in a game being conducted on a gaming system 105. In some cases, the player self-service instructions 330 can further cause the processor 305 to provide, through the communications interface 320 an indication of an available activity. For example, the indication can comprise causing the gaming system 105 to present a QR code or message, sending a message to a mobile device 135 of the player, etc. The player self-service instructions 330 can further cause the processor 305 to receive, through the communication interface 320, an indication of acceptance by the player 120, e.g., the gaming system 105 or player’s mobile device 135 accessing a URL and/or requesting a service provided by the host system 115. In response, the player self-service instructions 330 can cause the processor 305 to conduct the activity, e.g., completing a form, registering the player, or other activity as described above.

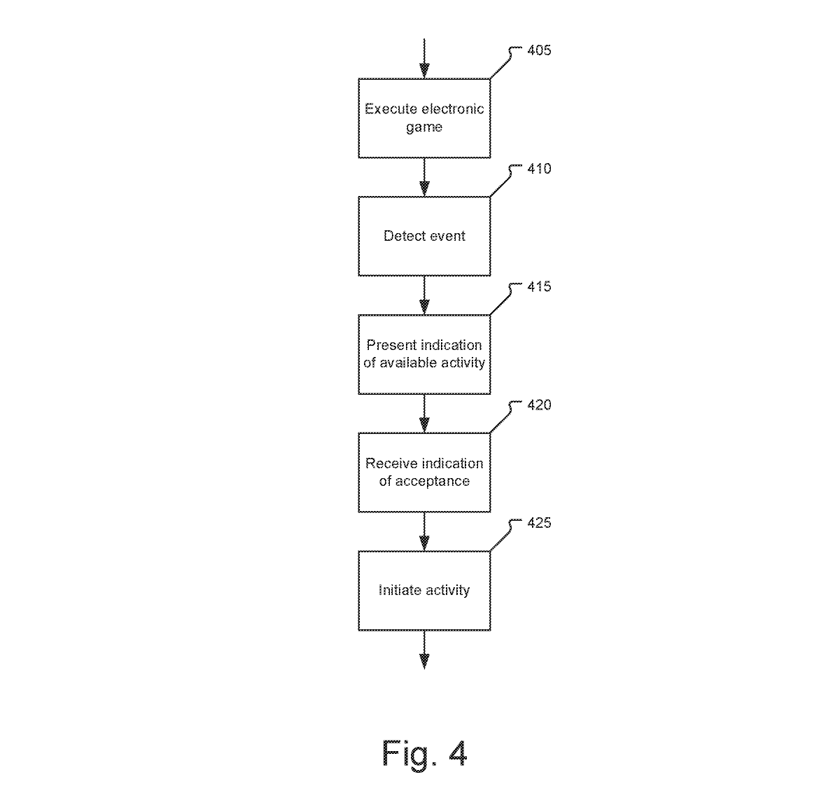

FIG. 4 is a flowchart illustrating an exemplary process for initiating and conducting activities to process events occurring at a gaming system according to one embodiment of the present disclosure. More specifically, this example illustrates a process as may be performed by a gaming system 105 as described above. As illustrated in this example, the process can begin with executing 405 an electronic game and detecting 410 an event occurring within the electronic game. For example, the event can comprise a win event.

An indication of an available activity can be presented 415 to a player 120 of the electronic game. In some cases, the indication of the available activity can comprise a QR code 130. In some cases, the QR code 130 can further comprise a transaction identifier. Additionally, or alternatively, the QR code 130 can further comprise an identifier of the gaming system 105. In another example, the indication of the available activity can comprise a message to the player 120 of the electronic game. For example, the message can comprise a message to a mobile device 135 of the player 120 and the message can comprise a link 140 with a URL to a service for performing the available activity. In other cases, the device of the player of the electronic game can comprise an augmented reality device or a virtual reality device.

The available activity can comprise, for example, completing a form related to the win event. Additionally, or alternatively, the available activity can comprise creating an account for the player of the electronic game, bonusing related activity for the electronic game, presenting an offer to the player of the electronic game, processing a jackpot of the electronic game, and/or other activity.

An indication of acceptance of the indicated available activity by the player of the electronic game can be received 420. The indication of acceptance can comprise, for example, the player pairing a mobile device 135 with the gaming system or a message from the mobile device or host system 115 indicating acceptance by the player 120. The indicated available activity with the player of the electronic game can then be initiated 425 in response to the received 420 indication of acceptance of the indicated available activity from the player of the electronic game. Initiating 425 the activity can comprise launching a process and conducting the activity on the gaming system 105 and/or requesting processing by a host system 115 to conduct the activity in whole or in part.

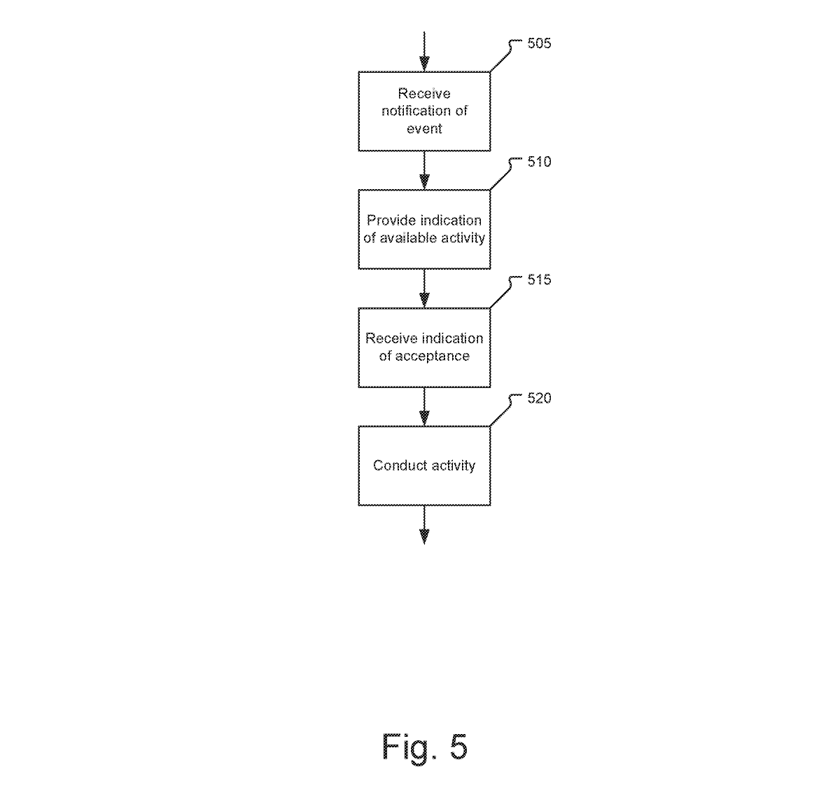

FIG. 5 is a flowchart illustrating an exemplary process for initiating and conducting activities to process events occurring at a gaming system according to another embodiment of the present disclosure. More specifically, this example illustrates processes that may be performed by a host system 115 as described above. As illustrated in this example, initiating and conducting activities to process events occurring at a gaming system can comprise receiving 505 notification of an event, e.g., a win event, occurring in a game being conducted on a gaming system 105. In some cases, the host system 115 can provide 510 an indication of an available activity. For example, the indication can comprise causing the gaming system 105 to present a QR code or message, sending a message to a mobile device 135 of the player, etc. An indication of acceptance by the player 120 can be received 515, e.g., the gaming system 105 or player’s mobile device 135 accessing a URL and/or requesting a service provided by the host system 115. In response, the host system 115 can conduct 520 the activity, e.g., completing a form, registering the player, or other activity as described above.

A number of variations and modifications of the disclosure can be used. It would be possible to provide for some features of the disclosure without providing others.

The present disclosure contemplates a variety of different gaming systems each having one or more of a plurality of different features, attributes, or characteristics. A “gaming system” as used herein refers to various configurations of: (a) one or more central servers, central controllers, or remote hosts; (b) one or more electronic gaming machines such as those located on a casino floor; and/or (c) one or more personal gaming devices, such as desktop computers, laptop computers, tablet computers or computing devices, personal digital assistants, mobile phones, and other mobile computing devices. Moreover, an EGM as used herein refers to any suitable electronic gaming machine which enables a player to play a game (including but not limited to a game of chance, a game of skill, and/or a game of partial skill) to potentially win one or more awards, wherein the EGM comprises, but is not limited to: a slot machine, a video poker machine, a video lottery terminal, a terminal associated with an electronic table game, a video keno machine, a video bingo machine located on a casino floor, a sports betting terminal, or a kiosk, such as a sports betting kiosk.

In various embodiments, the gaming system of the present disclosure includes: (a) one or more electronic gaming machines in combination with one or more central servers, central controllers, or remote hosts; (b) one or more personal gaming devices in combination with one or more central servers, central controllers, or remote hosts; (c) one or more personal gaming devices in combination with one or more electronic gaming machines; (d) one or more personal gaming devices, one or more electronic gaming machines, and one or more central servers, central controllers, or remote hosts in combination with one another; (e) a single electronic gaming machine; (f) a plurality of electronic gaming machines in combination with one another; (g) a single personal gaming device; (h) a plurality of personal gaming devices in combination with one another; (i) a single central server, central controller, or remote host; and/or (j) a plurality of central servers, central controllers, or remote hosts in combination with one another.

For brevity and clarity and unless specifically stated otherwise, “EGM” as used herein represents one EGM or a plurality of EGMs, “personal gaming device” as used herein represents one personal gaming device or a plurality of personal gaming devices, and “central server, central controller, or remote host” as used herein represents one central server, central controller, or remote host or a plurality of central servers, central controllers, or remote hosts.

As noted above, in various embodiments, the gaming system includes an EGM (or personal gaming device) in combination with a central server, central controller, or remote host. In such embodiments, the EGM (or personal gaming device) is configured to communicate with the central server, central controller, or remote host through a data network or remote communication link. In certain such embodiments, the EGM (or personal gaming device) is configured to communicate with another EGM (or personal gaming device) through the same data network or remote communication link or through a different data network or remote communication link. For example, the gaming system includes a plurality of EGMs that are each configured to communicate with a central server, central controller, or remote host through a data network.

In certain embodiments in which the gaming system includes an EGM (or personal gaming device) in combination with a central server, central controller, or remote host, the central server, central controller, or remote host is any suitable computing device (such as a server) that includes at least one processor and at least one memory device or data storage device. As further described herein, the EGM (or personal gaming device) includes at least one EGM (or personal gaming device) processor configured to transmit and receive data or signals representing events, messages, commands, or any other suitable information between the EGM (or personal gaming device) and the central server, central controller, or remote host. The at least one processor of that EGM (or personal gaming device) is configured to execute the events, messages, or commands represented by such data or signals in conjunction with the operation of the EGM (or personal gaming device). Moreover, the at least one processor of the central server, central controller, or remote host is configured to transmit and receive data or signals representing events, messages, commands, or any other suitable information between the central server, central controller, or remote host and the EGM (or personal gaming device). The at least one processor of the central server, central controller, or remote host is configured to execute the events, messages, or commands represented by such data or signals in conjunction with the operation of the central server, central controller, or remote host. One, more than one, or each of the functions of the central server, central controller, or remote host may be performed by the at least one processor of the EGM (or personal gaming device). Further, one, more than one, or each of the functions of the at least one processor of the EGM (or personal gaming device) may be performed by the at least one processor of the central server, central controller, or remote host.

In certain such embodiments, computerized instructions for controlling any games (such as any primary or base games and/or any secondary or bonus games) displayed by the EGM (or personal gaming device) are executed by the central server, central controller, or remote host. In such “thin client” embodiments, the central server, central controller, or remote host remotely controls any games (or other suitable interfaces) displayed by the EGM (or personal gaming device), and the EGM (or personal gaming device) is utilized to display such games (or suitable interfaces) and to receive one or more inputs or commands. In other such embodiments, computerized instructions for controlling any games displayed by the EGM (or personal gaming device) are communicated from the central server, central controller, or remote host to the EGM (or personal gaming device) and are stored in at least one memory device of the EGM (or personal gaming device). In such “thick client” embodiments, the at least one processor of the EGM (or personal gaming device) executes the computerized instructions to control any games (or other suitable interfaces) displayed by the EGM (or personal gaming device).

In various embodiments in which the gaming system includes a plurality of EGMs (or personal gaming devices), one or more of the EGMs (or personal gaming devices) are thin client EGMs (or personal gaming devices) and one or more of the EGMs (or personal gaming devices) are thick client EGMs (or personal gaming devices). In other embodiments in which the gaming system includes one or more EGMs (or personal gaming devices), certain functions of one or more of the EGMs (or personal gaming devices) are implemented in a thin client environment, and certain other functions of one or more of the EGMs (or personal gaming devices) are implemented in a thick client environment. In one such embodiment in which the gaming system includes an EGM (or personal gaming device) and a central server, central controller, or remote host, computerized instructions for controlling any primary or base games displayed by the EGM (or personal gaming device) are communicated from the central server, central controller, or remote host to the EGM (or personal gaming device) in a thick client configuration, and computerized instructions for controlling any secondary or bonus games or other functions displayed by the EGM (or personal gaming device) are executed by the central server, central controller, or remote host in a thin client configuration.

In certain embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include a local area network (LAN) in which the EGMs (or personal gaming devices) are located substantially proximate to one another and/or the central server, central controller, or remote host. In one example, the EGMs (or personal gaming devices) and the central server, central controller, or remote host are located in a gaming establishment or a portion of a gaming establishment.

In other embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include a wide area network (WAN) in which one or more of the EGMs (or personal gaming devices) are not necessarily located substantially proximate to another one of the EGMs (or personal gaming devices) and/or the central server, central controller, or remote host. For example, one or more of the EGMs (or personal gaming devices) are located: (a) in an area of a gaming establishment different from an area of the gaming establishment in which the central server, central controller, or remote host is located; or (b) in a gaming establishment different from the gaming establishment in which the central server, central controller, or remote host is located. In another example, the central server, central controller, or remote host is not located within a gaming establishment in which the EGMs (or personal gaming devices) are located. In certain embodiments in which the communication network includes a WAN, the gaming system includes a central server, central controller, or remote host and an EGM (or personal gaming device) each located in a different gaming establishment in a same geographic area, such as a same city or a same state. Gaming systems in which the communication network includes a WAN are substantially identical to gaming systems in which the communication network includes a LAN, though the quantity of EGMs (or personal gaming devices) in such gaming systems may vary relative to one another.

In further embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include an internet (such as the Internet) or an intranet. In certain such embodiments, an Internet browser of the EGM (or personal gaming device) is usable to access an Internet game page from any location where an Internet connection is available. In one such embodiment, after the EGM (or personal gaming device) accesses the Internet game page, the central server, central controller, or remote host identifies a player before enabling that player to place any wagers on any plays of any wagering games. In one example, the central server, central controller, or remote host identifies the player by requiring a player account of the player to be logged into via an input of a unique player name and password combination assigned to the player. The central server, central controller, or remote host may, however, identify the player in any other suitable manner, such as by validating a player tracking identification number associated with the player; by reading a player tracking card or other smart card inserted into a card reader; by validating a unique player identification number associated with the player by the central server, central controller, or remote host; or by identifying the EGM (or personal gaming device), such as by identifying the MAC address or the IP address of the Internet facilitator. In various embodiments, once the central server, central controller, or remote host identifies the player, the central server, central controller, or remote host enables placement of one or more wagers on one or more plays of one or more primary or base games and/or one or more secondary or bonus games, and displays those plays via the Internet browser of the EGM (or personal gaming device). Examples of implementations of Internet-based gaming are further described in U.S. Patent No. 8,764,566, entitled “Internet Remote Game Server,” and U.S. Patent No. 8,147,334, entitled “Universal Game Server.”

The central server, central controller, or remote host and the EGM (or personal gaming device) are configured to connect to the data network or remote communications link in any suitable manner. In various embodiments, such a connection is accomplished via: a conventional phone line or other data transmission line, a digital subscriber line (DSL), a T-1 line, a coaxial cable, a fiber optic cable, a wireless or wired routing device, a mobile communications network connection (such as a cellular network or mobile Internet network), or any other suitable medium. The expansion in the quantity of computing devices and the quantity and speed of Internet connections in recent years increases opportunities for players to use a variety of EGMs (or personal gaming devices) to play games from an ever-increasing quantity of remote sites. Additionally, the enhanced bandwidth of digital wireless communications may render such technology suitable for some or all communications, particularly if such communications are encrypted. Higher data transmission speeds may be useful for enhancing the sophistication and response of the display and interaction with players.

As should be appreciated by one skilled in the art, aspects of the present disclosure have been illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the "C" programming language, Visual Basic, Fortran 2003, Perl, COBOL 2002, PHP, ABAP, dynamic programming languages such as Python, Ruby and Groovy, or other programming languages. The program code may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure have been described herein with reference to flowchart illustrations and/or block diagrams of methods, apparatuses (systems) and computer program products according to embodiments of the disclosure. It should be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

What is claimed is:

1. A gaming system comprising:
a processor; and
a memory coupled with and readable by the processor and storing therein a set of instructions which, when executed by the processor, causes the processor to:
execute an electronic game;
detect an event occurring within the electronic game;
present, to a player of the electronic game, an indication of an available activity;
receive an indication of acceptance of the indicated available activity by the player of the electronic game; and
initiate the indicated available activity with the player of the electronic game in response to the received indication of acceptance of the indicated available activity from the player of the electronic game.

2. The gaming system of claim 1, wherein the indication of the available activity comprises a Quick-Response (QR) code.

3. The gaming system of claim 2, wherein the QR code further comprises a transaction identifier.

4. The gaming system of claim 2, wherein the QR code further comprises an identifier of the gaming system.

5. The gaming system of claim 1, wherein the indication of the available activity comprises a message to the player of the electronic game.

6. The gaming system of claim 1, wherein the event occurring within the electronic game comprises a win event and wherein the available activity comprises completing a form related to the win event.

7. The gaming system of claim 1, wherein the available activity comprises creating an account for the player of the electronic game.

8. The gaming system of claim 1, wherein the available activity comprises a bonusing related activity for the electronic game.

9. The gaming system of claim 1, wherein the available activity comprises activity presenting an offer to the player of the electronic game.

10. The gaming system of claim 1, wherein the event occurring within the electronic game comprises a win event and wherein the available activity comprises processing a jackpot of the electronic game.

11. A system comprising:
a communications network;
a gaming system coupled with the communications network, the gaming system comprising a processor and a memory coupled with and readable by the processor of the gaming system and storing therein a set of instructions which, when executed by the processor of the gaming system, causes the processor of the gaming system to:
execute an electronic game,
detect an event occurring within the electronic game, and
present, to a player of the electronic game, an indication of an available self-service activity; and
a host system coupled with the communications network, the host system comprising a processor and a memory coupled with and readable by the processor of the host system which, when executed by the processor of the host system, causes the processor of the host system to:
initiate the indicated available activity with the player of the electronic game in response to an indication of acceptance of the indicated available activity from the player of the electronic game.

12. The system of claim 11, wherein the indication of the available activity comprises a Quick-Response (QR) code.

13. The system of claim 12, wherein the QR comprises a link to a Uniform Resource Locator (URL) provided by the host system.

14. The system of claim 11, wherein the indication of the available activity comprises a message to the player of the electronic game.

15. The system of claim 14, wherein the message to the player of the electronic game instructs the player to connect with the gaming system via a device of the player.

16. The system of claim 14, wherein the device of the player comprises a smartphone and the message comprises a text message to the smartphone of the player.

17. The system of claim 16, wherein the text message is sent by the host system in response to a request from the gaming system.

18. The system of claim 14, wherein the device of the player of the electronic game comprises an augmented reality device.

19. The system of claim 14, wherein the device of the player of the electronic game comprises a virtual reality device.

20. A method for conducting a self-service activity with a player of an electronic game, the method comprising:
executing, by a processor of a gaming system, an electronic game;
detecting, by the processor of the gaming system, an event occurring within the electronic game;
present, to a player of the electronic game, an indication of an available activity;
receiving, by the processor of the gaming system, an indication of acceptance of the indicated available activity by the player of the electronic game; and
initiating, by the processor of the gaming system, the indicated available activity with the player of the electronic game in response to the received indication of acceptance of the indicated available activity from the player of the electronic game.
